(19) United States
(12) Patent Application Publication
(10) Pub. No.: US 2026/0039371 A1
(43) Pub. Date: Feb. 5, 2026

(54) METHOD, SYSTEM AND ELECTRONIC DEVICE OF DATE COMMUNICATION

(71) Applicant: Dalian University, Dalian City (CN)

(72) Inventors: Zhiguo LIU, Dalian City (CN); Qing Zou, Dalian City (CN); Lin Wang, Dalian City (CN)

(21) Appl. No.: 18/906,321

(22) Filed: Oct. 4, 2024

Related U.S. Application Data
(63) Continuation of application No. PCT/CN2024/111519, filed on Aug. 12, 2024.

(30) Foreign Application Priority Data
Jul. 31, 2024 (CN) 202411045828.9

(51) Int. Cl. H04B 7/185; H04L 67/63

(52) U.S. Cl. CPC H04B 7/18513; H04L 67/63

(57) ABSTRACT

The present disclosure relates to the field of communication and provides a method, a system and an electronic device of date communication. The method includes: the data name information uploaded by the producer is received through the pre-built satellite data depot, which includes at least three geosynchronous earth orbit satellites and several low-orbit satellites, and the data name information characterizes the data characterized by the producer; and the data in the satellite data depot is updated based on the data name information. In order to solve the defect that if a producer moves in an NDN network architecture, a consumer is difficult to locate a new position of the producer, so that a sent interest packet reaches an old position of the producer, and the packet is lost, which greatly affects the accuracy and efficiency of data transmission, the data packet of the moving producer can be cached in the data depot based on the pre-built satellite data depot in the solution of the present application, so that the influence of the movement of the producer on the network performance can be effectively shielded.

### CROSS REFERENCE TO RELATED APPLICATION

This patent application is a Continuation of International Application No. PCT/CN2024/111519 filed on Aug. 12, 2024, which claims the benefit and priority of Chinese Patent Application No. 2024110458289 filed on Jul. 31, 2024, the disclosures of which are incorporated by reference herein in their entireties as part of the present application.

### TECHNICAL FIELD

The present disclosure relates to the field of communication technology, in particular to a method, a system and an electronic device of date communication.

### BACKGROUND ART

With the rapid development of data communication technology and its hardware technology, the connectivity and low storage cost provided by the Internet make a large number of new content can be accessed, and the amount of data in the network is growing at an astonishing rate, which puts forward higher requirements for the bandwidth and delay of content transmission of the network architecture, and the named data networking (NDN) is one of the future network architectures that meets this higher requirement.

In the NDN network architecture, the producer refers to a node or a device that can provide data or content to meet the needs of consumers. It should be noted that in practical applications, the producer is often mobile, and when the producer moves, it is difficult for the consumers to locate the new location of the producer, resulting in the sent interest packets will reach the old location of the producer, resulting in packet loss, which will greatly affect the accuracy and the efficiency of data transmission.

### SUMMARY

The present disclosure provides a method, a system, and an electronic device of data communication to solve the problem that when the producer moves in the NDN network architecture, it is difficult for the consumers to locate the new location of the producer, resulting in the sent interest packets will reach the old location of the producer, resulting in packet loss, greatly affecting defects of the accuracy and the efficiency of the data transmission. In the solution of the present application, the data generated by the producer can be cached based on the pre-built satellite data depot, so that the impact of producer movement on network performance can be effectively shielded.

The present disclosure provides a data communication method, including:
receiving the data name information uploaded by the producer through the pre-built satellite data depot. The satellite data depot includes at least three geosynchronous earth orbit satellites and several low-orbit satellites, and the data name information characterizes the data produced by the producer; and
updating the data in the satellite data depot based on the data name information.

According to the data communication method provided by the present disclosure, it also includes: forwarding the request packet to the producer if the satellite data depot receives the request packet of the consumer; and
receiving the data packet uploaded by the producer based on the request packet and forwarding the data packet to the consumer through the satellite data depot.

According to the data communication method provided by the present disclosure, the forwarding the request packet to the producer if the satellite data depot receives the request packet of the consumer includes:
receiving the request packet of the consumer through the low-orbit satellites;
marking the request packet based on the data name information; and
routing the request packet to the producer based on markings.

According to the data communication method provided by the present disclosure, the satellite data depot receives the data name information uploaded by the producer through the target satellite, and the target satellite is one of several low-orbit satellites.

The routing the request packet to the producer based on the markings includes:
routing the request packet to the target satellite based on the preset routing rules, wherein the address of the target satellite corresponds to the markings; and
forwarding the request packet to the producer based on the data name information of the producer through the target satellite.

According to the data communication method provided by the present disclosure, it also includes:
forwarding the cached data packet to the consumer if the satellite data depot receives the request packet of the consumer, and it is determined that the satellite data depot has cached the data packet corresponding to the request packet.

According to the data communication method provided by the present disclosure, the satellite data depot caches the data packet by the following method:
determining the number of times that the date packet is requested;
determining a corresponding number of hops for each low-orbit satellite through which the data packet passes if the data packet is requested each time;
calculating the cache probability of each low-orbit satellite to the data packet based on the requested times and the hop times of the data packet; and
caching the data packet based on the cache probability through each low-orbit satellite.

According to the data communication method provided by the present disclosure, a routing table is set in the satellite data depot. The routing table includes a satellite-ground communication routing table and a inter-satellite communication routing table. The low-orbit satellites are distributed in several orbits. The construction method of the inter-satellite communication routing table includes:
sending the first information to the low-orbit satellite in the same orbit for each low-orbit satellite, the first information characterizes the location of the low-orbit satellite;
creating and storing the inter-satellite communication routing table in the low-orbit satellite in the same orbit if the low-orbit satellite in the same orbit receives the first information, and the inter-satellite communication routing table corresponding to the low-orbit satellite is not stored in the low-orbit satellite in the same orbit; updating the inter-satellite communication routing table based on the first information if the inter-satellite communication routing table corresponding to the low-orbit satellite has been stored;
sending the second information to the low-orbit satellites of different orbits every set time for each low-orbit satellite, the second information characterizes the position of the low-orbit satellite; and
creating and storing the inter-satellite communication routing table in the low-orbit satellite in different orbits if the low-orbit satellite in different orbits receives the second information, and the inter-satellite communication routing table corresponding to the low-orbit satellite is not stored in the low-orbit satellite in different orbits; updating the inter-satellite communication routing table based on the second information if the inter-satellite communication routing table corresponding to the low-orbit satellite has been stored.

According to the data communication method provided by the present disclosure, the updating the data in the satellite data depot based on the data name information includes:
updating the data of the target satellite based on the data name information; and
updating the data of all low-orbit satellites and geosynchronous earth orbit satellites in the satellite data depot.

The present disclosure also provides a data communication system, including:
an information receiving module, which is configured to receive the data name information uploaded by the producer through the pre-built satellite data depot. The satellite data depot includes at least three geosynchronous earth orbit satellites and several low-orbit satellites, and the data name information characterizes the data produced by the producer; and
an information update module, which is configured to update the data in the satellite data depot based on the data name information.

The present disclosure also provides an electronic device, including a memory, a processor, and a computer program stored on the memory and executable on the processor. If the processor executes the program, it implements any of the above data communication methods.

The present disclosure also provides a non-transient computer readable storage medium having stored thereon a computer program that, if executed by the processor, implementes as any of the above data communication methods.

The present disclosure also provides a computer program product, including a computer program which, if executed by the processor, implementes as any of the above data communication methods.

In the data communication method provided by the present disclosure, a satellite data depot can be constructed in advance which can receive the data name information uploaded by the producer. Because the data name information can characterize the data produced by the producer, even if the producer is in the process of moving, the satellite data depot can also obtain the data produced by the producer. In this way, efficient communication between the producer and the consumer is realized, and the accuracy and the efficiency of the data transmission are improved.

### BRIEF DESCRIPTION OF THE DRAWINGS

In order to more clearly illustrate the technical solutions of the present disclosure or in the related art, the accompanying drawings used in the embodiments or the related art will now be described briefly. It is obvious that the drawings in the following description are some embodiments of the disclosure, and that those ordinary in the art can obtain other drawings from these drawings without any creative efforts.

FIG. 1 is one of the flow diagrams of the data communication method provided by the embodiment of the disclosure;

FIG. 2 is one of the structural diagrams of the satellite data depot provided by the embodiment of the disclosure;

FIG. 3 is the second structure diagram of the satellite data depot provided by the embodiment of the disclosure;

FIG. 4 is a structure diagram of the routing table provided by the embodiment of the disclosure;

FIG. 5 is the second flow diagram of the data communication method provided by the embodiment of the disclosure;

FIG. 6 is the third flow diagram of the data communication method provided by the embodiment of the disclosure;

FIG. 7 is the fourth flow diagram of the data communication method provided by the embodiment of the disclosure;

FIG. 8 is a consumer delay graph under different amounts of managers provided by the embodiment of the disclosure;

FIG. 9 is a signaling overhead graph under different amounts of managers provided by the embodiment of the disclosure;

FIG. 10 is a delivery rate graph under different amounts of managers provided by the embodiment of the disclosure;

FIG. 11 is a influence result graph of different intranet caching strategies on the performance of MsDD provided by the embodiment of the disclosure;

FIG. 12 is the consumer delay graph under different producer movement rates provided by the embodiment of the disclosure;

FIG. 13 is a delivery rate graph under different producer movement rates provided by the embodiment of the disclosure;

FIG. 14 is a signaling overhead graph under different producer movement rates provided by the embodiment of the disclosure;

FIG. 15 is a structure diagram of the data communication system provided by the embodiment of the disclosure; and

FIG. 16 is a diagram of the physical structure of the electronic device provided by the embodiment of the disclosure.

### DETAILED DESCRIPTION OF THE EMBODIMENTS

In order to make the purpose, technical solutions and advantages of the present disclosure clearer, the technical solutions of the present disclosure will be clearly and completely described with reference to the drawings in the embodiments of the present disclosure. Obviously, the described embodiments are only a part of the embodiments of the present disclosure, but not all the embodiments thereof. Based on the embodiments of the present disclosure, all other embodiments obtained by those skilled in the art without any creative efforts shall fall within the scope of the present disclosure.

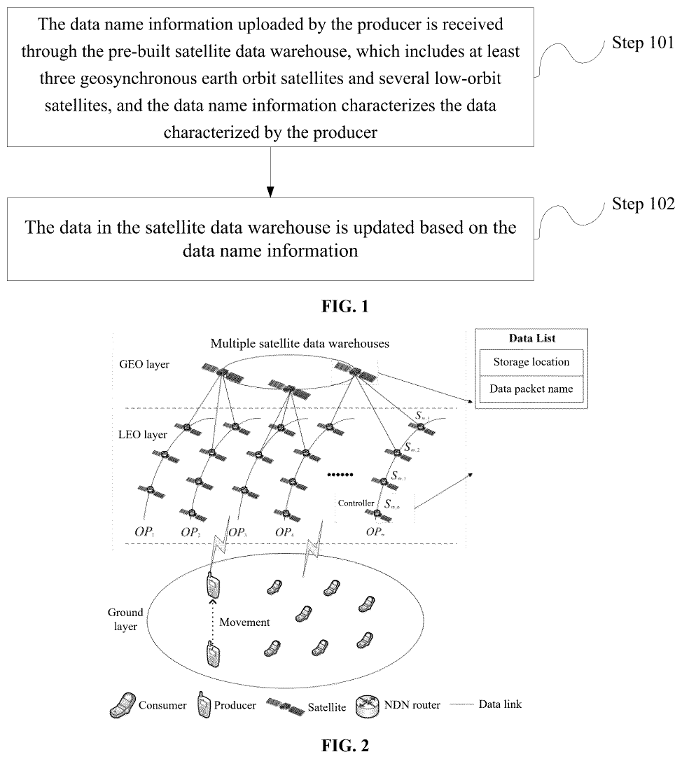

FIG. 1 is one of the flow diagrams of the data communication method provided by the embodiment of the disclosure.

As shown in FIG. 1, this embodiment provides a data communication method, including:

Step 101, the data name information uploaded by the producer is received through the pre-built satellite data depot, which includes at least three geosynchronous earth orbit satellites and several low-orbit satellites, and the data name information characterizes the data characterized by the producer; and

Step 102, the data in the satellite data depot is updated based on the data name information.

FIG. 2 is one of the structural diagrams of the satellite data depot provided by the embodiment of the disclosure.

As shown in FIG. 2, the satellite data depot provided in this embodiment includes Low Earth Orbit (LEO) Satellite constellation and Geosynchronous Earth Orbit (GEO) constellation. The GEO satellite constellation is formed by at least three GEO satellites distributed at equal intervals over the equator, and the orbital plane coincides with the equatorial plane. The LEO satellite constellation is a Walker constellation including m ordered polar orbit plane, and Each orbit is evenly distributed with n ordered arrangement of LEO satellites, so there are m×n+3 low-orbit satellites to form the data depot. The producers and consumers on the ground in the NDN architecture can directly communicate with the LEO layer satellite through hardware devices.

In the practical application, the LEO satellites can be distributed in different orbits, and can be defined by the prefix /sat/OPₕ/SPᵢ, wherein/sat is that the node is a satellite node, /OPₕ is the orbit in which it is located, /SPᵢ is its number in the current orbit, that is, h is the orbit where the LEO satellite is located, i is the number of the LEO satellite in the current orbit, so the set of low-orbit satellite nodes satisfies S={S_{h,i}, h=1, 2, . . . , m, i=1, 2, . . . n}.

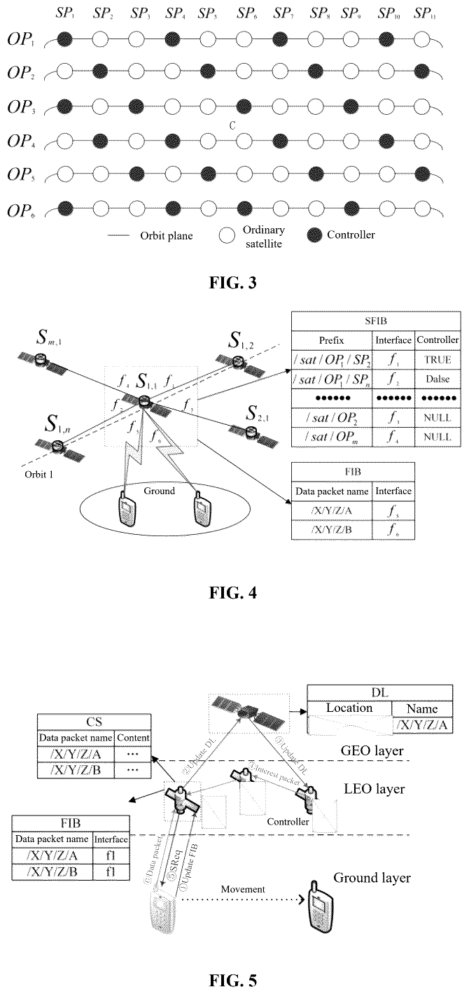

FIG. 3 is the second structure diagram of the satellite data depot provided by the embodiment of the disclosure.

In the embodiment, as shown in FIG. 3, the LEO satellites include managers and non-managers. For example, the amounts of the managers in each orbital plane is M, and they are placed at intervals of

$$⌈ \frac{n}{M} ⌉ - 1$$

nodes within the orbit. In addition, if one of the managers on orbit OPₕ is S_{h,i}, the manager of the adjacent orbit OPₕ₊₁ is S_{h+1,i+1}, and the other orbits are the same. Such an arrangement method can keep a basic consistency in the amount of managers across different latitudes. FIG. 3 illustrates the arrangement of LEO satellites, when n=11,m=6, and M=4.

In the embodiment, the data list table DL can be set in the satellite data depot, and the data name information can be stored in the data list table. And the amount of data list entries can be multiple, preferably, each manager can work with three GEO satellites to maintain a DL table with the same content. If the DL table information of one manager changes, update information can be sent to the GEO satellite covering it, and then this update information will be sent to other managers by the GEO satellite to achieve the purpose of global update. A DL entry includes a packet storage location (node prefix) and a packet name prefix.

In the embodiment, the data name information can also characterize the location of the producer after moving.

In the data communication method provided by this embodiment, a satellite data depot can be constructed in advance, the satellite data depot can receive the data name information uploaded by the producer, and since the data name information can characterize the address of the producer, even if the producer is in the process of moving, the satellite data depot can also obtain the data produced by the producer. In this way, efficient communication between the producer and the consumer is realized, and the accuracy and the efficiency of data transmission are improved.

In the example embodiment, the data communication method also includes:
if the satellite data depot receives a request packet of the consumer, forwarding the request packet to the producer; and
the data packet uploaded by the producer is received based on the request packet and the data packet is forwarded to the consumer through the satellite data depot.

In the practical applications, the satellite data depot receives the data name information uploaded by the producer and the request packet of the consumer through the low-orbit satellite, but the low-orbit satellite that receives the data name information uploaded by the producer and the low-orbit satellite that receives the request packet of the consumer may not be the same low-orbit satellite. In this case, it is necessary to forward the received request packet of the consumer to the low-orbit satellite corresponding to the producer. In this process, the request packet can be forwarded through the DL table managed by the manager. If the request packet is forwarded to the low-orbit satellite corresponding to the producer, the low-orbit satellite then forwards the request packet to the producer based on the stored data name information, and then receives the data packet uploaded by the producer based on the request packet, and gradually forwards the data packet to the consumer sending the request packet.

In this embodiment, the consumers play the role of requesting data packets from the producers, and on the premise that the satellite data depot can accurately locate the location of producers through the data name information, the consumers can obtain the required data packets accurately and in real time to improve the efficiency of data communication.

In the example embodiments, if the satellite data depot receives the request packet of the consumer, the request packet is forwarded to the producer, includes:
the request packet of consumer is received through low-orbit satellites;
the request packet is marked based on the data name information; and
request packet is routed to the producer based on markings.

In the practical application, in the process of forwarding the request packet to the producer, since the non-manager does not carry the DL, the prefix name of the low-orbit satellite corresponding to the producer needs to be obtained through the DL carried by the manager. Therefore, the low-orbit satellites of non-manager need to first forward the interest packet to the nearest manager in the same orbit through the FIB entry. The data packet is sent by the consumer and carries the request packet, and then the manager adds a forwarding hint for the interest packet, that is, marks the request packet. The forwarding hint is a locator carried in the interest packet, indicating that the interest packet is forwarded to ‘where’. Through forwarding tips, the core network of NDN can only announce the location in the form of prefix, which is more scalable than announcing the data name prefix. Since each satellite in the LEO layer has its unique prefix name set when constructing the LEO layer, the prefix name of the target node can be used as a forwarding hint to route the interest packet in the embodiment.

In this embodiment, the request packet can be accurately forwarded to the producer by attaching a marking to the request packet.

In the example embodiment, the satellite data depot receives the data name information uploaded by the producer through the target satellite, and the target satellite is one of several low-orbit satellites.

The request packet is routed to the producer based on markings, including:
the request packet is routed to the target satellite based on the preset routing rules, and the address of the target satellite corresponds to the markings; and
the request packet is forwarded to the producer through the target satellite based on the data name information of the producer.

In the practical applications, the default routing rules are as follows:

```
  Require:
  /sat/OPₕ/SPᵢ: define the prefix of S_{h,i}
  /sat/OPₕ_{⁺}/SPᵢ_{⁺}: define the prefix of target node Sₕ_{⁺}_{,i}_{⁺},
which is used as a forwarding hint for the interest packet Dᵢₙₜ
  /sat/OP₀: take it as /sat/OPₘ
  D: the data packet requested by the interest packet Dᵢₙₜ
  Begin
    for Dᵢₙₜ is forwarded to a new node S_{h,i} do
      if S_{h,i} has been cached in CS of D then
      complete the forwarding process
    end if
    if there is an entry named D in the PIT entries of S_{h,i} then
      complete the forwarding process
    end if
    if h = = h⁺ then
      if i = = i⁺ then
      complete the forwarding process
      else
        by finding SFIB, Dᵢₙₜ is forwarded from the interface
prefixed with /sat/OPₕ_{⁺}/SPᵢ_{⁺} to a new node
      end if
    else if h < h⁺ then
      $if \vert h - {h}^{+} \vert > \frac{m}{2} then$
        by finding SFIB, Dᵢₙₜ is forwarded from the interface prefixed
with /sat/OPₕ₋₁ to a new node
      else
        by finding SFIB, Dᵢₙₜ is forwarded from the interface prefixed
with /sat/OP_{(h+1) mod m} to a new node
      end if
    else
      $if \vert h - {h}^{+} \vert > \frac{m}{2} then$
        by finding SFIB, Dᵢₙₜ is forwarded from the interface prefixed
with /sat/OP_{(h+1) mod m} to a new node
        else
        by finding SFIB, Dᵢₙₜ is forwarded from the interface
prefixed with /sat/OPₕ₋₁ to a new node
        end if
      end if
    end for
  End
```

In the example embodiment, the data communication method also includes:

If the satellite data depot receives the request packet of the consumer, and it is determined that the satellite data depot has cached the data packet corresponding to the request packet, the cached data packet is forwarded to the consumer.

In the practical application, the consumer may request data packets from the same producer repeatedly, and different consumers may request the same data packet from the same producer, in these cases, the satellite data depot can cache the data packets uploaded by the producer. In this way, when confirming the same data packets requested by the request packets, the pre-cached data packets can be directly forwarded from the satellite data depot to the consumer sending the request packets, without the need to forward the request packets to the producer, which can improve the efficiency of data communication.

In the example embodiment, the satellite data depot caches the data packets through the following method:
the number of times of the date packet requested is determined;
a corresponding number of hops for each low-orbit satellite through which the data packet passes if the data packet is requested each time is determined;
the cache probability of each low-orbit satellite to the data packet is calculated based on the requested times and the hop times of the data packet; and
the data packet is cached through each low-orbit satellite based on the cache probability.

In the practical application, the number of hops of the data packets of the producer can be represented by the number of hops that the request packets sent by the consumer to be forwarded to the producer. In the embodiment, if the satellite data depot receives the request packet from the consumer, a TLV element named ISLhop can be added to the interest packet, which is responsible for recording the number of hops of forwarding the interest packet after passing through a manager node if forwarding the interest packet between different orbits. If the interest packet is forwarded within the same orbit, ISLhop=0. If the request packet is forwarded to a new node each time, that is, it is forwarded to a new low-orbit satellite, the low-orbit satellite records and updates ISLhop of the incoming interest packet from the interface communicating with two different orbit satellites.

If a data packet sent by a producer based on the request packet is forwarded between the low-orbit satellites, since the forwarding path of the producer is consistent with the forwarding path of the consumer, so each low-orbit satellite that the producer passes through is recorded with a TLV element named ISLhop. Therefore, if the data packet sent by the producer is forwarded to each low-orbit satellite, the probability of the low-orbit satellite caching the data packet can be calculated based on the number of hops recorded by ISLhop and the number of times that the packet is requested. Specifically, the probability can be calculated by the following formula:

$${P}_{( h , i ) , D} = {P}_{( h , i ) , D}^{diff} + {P}_{( h , i ) , D}^{same} - {P}_{( h , i ) , D}^{diff} \cdot {P}_{( h , i ) , D}^{same}$$

$${P}_{( h , i ) , D}^{diff} = \{ \begin{matrix}0 , {ISLhop}_{h , i} = 0 \\ {P}_{D} \cdot \frac{2 ε}{\sqrt{2 π}} {\int }_{{ISLhop}_{h , i} - 1}^{{ISLhop}_{h , i}} {e}^{- \frac{{( ε \cdot x )}^{2}}{2}} dx , {ISLhop}_{h , i} ∈ [ 1 , ⌈ \frac{m}{2} ⌉ ]\end{matrix}$$

$${P}_{( h , i ) , D}^{same} = \{ \begin{matrix}{P}_{D} , {hop}_{h , i} = 0 \\ {P}_{D} \cdot \frac{2 ε}{\sqrt{2 π}} {\int }_{{hop}_{h , i} - 1}^{{hop}_{h , i}} {e}^{- \frac{{( ε \cdot x )}^{2}}{2}} dx , {hop}_{h , i} = 1 , 2 , 3 , … , {hop}_{max}\end{matrix}$$

Wherein, P_{(h,i)},D is the cache probability of each low-orbit satellite,

$${P}_{( h , i ) , D}^{diff}$$

is the probability of the low-orbit satellite caching data packets if the data packets are forwarded through different orbits,

$${P}_{( h , i ) , D}^{same}$$

is the probability or the low-orbit satellite caching data packets if the data packets are forwarded through the same orbit, P_{D} is the cache probability calculated based on the CCS (Cache in the Core Strategy) solution, ε is the descending weight, and the larger the ε is, the greater the downward trend of P_{h,i} is. ISLhop_{h,i} is the ISLhop value of the corresponding low-orbit satellite, hopₘₐₓ is the maximum number of hop from the non-managerial low-orbit satellite to the managerial low-orbit satellite in the same orbit, and hop_{h,i} is the number of hop between the low-orbit satellite and the nearest manager in the same orbit.

In the practical application, hopₘₐₓ, hop_{h,i} and ISLhop_{h,i} can be calculated by the following formula:

$${hop}_{max} = ⌈ \frac{n - M}{2 M} ⌉$$

$${hop}_{h , i} = \{ \begin{matrix}\vert j - i \vert , & \vert j - i \vert \leq {hop}_{max} \\ n - \vert j - i \vert , & \vert j - i \vert > {hop}_{max}\end{matrix}$$

$${ISLhop}_{h , i} = \frac{{ISLhop}_{( h , i ) , {f}_{a}} + {ISLhop}_{( h , i ) , {f}_{b}}}{2}$$

Wherein, ISLhop_{(h,i),f}_{ₐ} is the ISLhop value incoming from the interface fₐ recorded by the current low-orbit satellite, ISLhop_{(h,i),f}_{_{b}} is the ISLhop value incoming from the interface f_{b} recorded by the low-orbit satellite, wherein fₐ is the communication interface between the low-orbit satellite and the satellites in different orbits, f_{b} is the communication interface between the low-orbit satellite and the satellites in the same orbit, h is the orbit of the LEO satellite, i is the number of the LEO satellite in the current orbit, m is the amount of orbits distributed by the low-orbit satellite, M is the amount of managers in each orbit, j is the number of managers in the current orbit.

In the example embodiment, if the target satellite in the satellite data depot receives the data packet uploaded by the producer, the data packet can be cached in the target satellite, and the target satellite is a low-orbit satellite that receives the data name information of the producer.

In the practical application, if the satellite data depot does not cache the data packet, the request packet of the consumer needs to be forwarded to the producer through the target satellite. In this embodiment, if the consumer first requests the data packet from the producer, the target satellite can cache the data packet. In this way, if the subsequent other consumers or this consumer requests the producer again for the data packet, the request packet can be directly obtained after being forwarded to the target satellite, and does not need to be forwarded to the producer. In this way, the efficiency of data communication can also be improved.

In the example embodiment, a routing table is set in the satellite data depot. The routing table includes a satellite-ground communication routing table and a inter-satellite communication routing table. The low-orbit satellites are distributed in several orbits. The construction method of the inter-satellite communication routing table includes:
for each low-orbit satellite, the first information is sent to the low-orbit satellite in the same orbit, the first information characterizes the location of the low-orbit satellite;
if the low-orbit satellite in the same orbit receives the first information, and the inter-satellite communication routing table corresponding to the low-orbit satellite is not stored in the same-orbit low-orbit satellite, the inter-satellite communication routing table is created and stored in the low-orbit satellite in the same orbit. If it has been stored, the inter-satellite communication routing table is updated based on the first information;
for each low-orbit satellite, the second information is sent to the low-orbit satellites of different orbits every set time for each low-orbit satellite, and the second information characterizes the position of the low-orbit satellite; and
if the low-orbit satellite in different orbits receives the second information, and the inter-satellite communication routing table corresponding to the low-orbit satellite is not stored in the low-orbit satellite in different orbits, the inter-satellite communication routing table is created and stored in the low-orbit satellite in different orbits; if it has been stored, the inter-satellite communication routing table is updated based on the second information.

In the practical application, FIB (Forwarding Information Base) table is a key data structure used to determine how interest packets are forwarded through the network in NDN networks. FIB itself is filled by a routing protocol with a name prefix, and each prefix can have multiple interfaces, which is crucial for data communication. The solution of this embodiment involves communication between satellites and communication between satellites and producers or consumers on the ground, so the routing table can include satellite-ground communication routing table and inter-satellite communication routing table. Wherein, the satellite-ground communication routing table can be represented by FIB. The FIB entry on the low-orbit satellite only includes different interfaces divided by the frequency band in the downlink. The inter-satellite communication routing table can use SFIB (Satellite FIB) to represent a SFIB entry including a prefix of the low-orbit satellite, a interface and a manager identification. The manager identification is configured to indicate whether the low-orbit satellite is a manager. On the other hand, in the solution of this embodiment, since the satellite data depot involves low-orbit satellites of different orbits, different routing rules need to be applied if data packets communicate between different orbits and in the same orbit. Therefore, in this embodiment, two different routing tables are constructed, in which the inter-satellite communication routing table of the same orbit is established as follows:
Step 1: for each low-orbit satellite S_{h,i}, a Pub-A message is sent from each of its two relay interfaces that communicate with the same-orbit satellite. The Pub-A message includes the prefix information of the low-orbit satellite itself, the number of the forwarding hops, and the manager identification; and
Step 2: the interface fₐ of the adjacent low-orbit satellite node s_{h,i}_{⁺} receiving the Pub-A message sent by S_{h,i}, the satellite node S_{h,i}_{⁺} performs the following processing:
If there is a SFIB entry with a prefix equal to /sat/OPₕ/SPᵢ in the node and the Pub-A has fewer forwarding hops, the entry is updated.
If there is a SFIB entry with a prefix equal to /sat/OPₕ/SPᵢ in the node, but the Pub-A has more forwarding hops, no adjustment is made.
If there is no SFIB entry with a prefix equal to /sat/OPₕ/SPᵢ in the node, the satellite node Sₕ_{⁺}_{,i}_{⁺} creates the SFIB entry with a prefix equal to /sat/OPₕ/SPᵢ, the interface is equal to fₐ, and the manager identification is recorded.

Because the order of the same-orbit satellites will not change, if the SFIB entries of the same-orbit satellites are completed, the node does not need to send the Pub-A message again to establish the entries.

The inter-satellite communication routing tables of different orbits are established as follows:
Step 1: S_{h,i} sends a Pub-B message from each of its two relay interfaces communicating with different orbit satellites every time interval τ, and τ is determined by the characteristics of different satellite constellations. Pub-B message contains the location (prefix) of S_{h,i};
Step 2: the interface f_{b} of the satellite node Sₕ_{⁺}_{, i}_{⁺} receives the Pub-B message sent by S_{h,i}, the the satellite node Sₕ_{⁺}_{,i}_{⁺} performs the following processing:
If there is a SFIB entry with a prefix equal to /sat/OPₕ in the node and the interface is consistent, no adjustment is made.
If there is a SFIB entry with a prefix equal to /sat/OPₕ in the node but the interface is inconsistent, the entry is updated.
If there is no SFIB entry with a prefix equal to /sat/OPₕ in the node, the satellite node Sₕ_{⁺}_{, i}_{⁺} creates the SFIB entry with a prefix equal to /sat/OPₕ, and the interface is equal to f_{b}.

FIG. 4 is the structure diagram of the routing table provided by the embodiment of the disclosure.

Through the above steps, a SFIB can be created for each LEO satellite node in MsDD, and each satellite node can communicate with other satellites in the LEO layer through the SFIB entry of the node itself. FIG. 4 shows the situation after the SFIB construction of satellite S_{1,1} is completed.

Due to the characteristics of the polar orbit satellite constellation, if the satellite passes through the north pole and south pole, its adjacent orbits will occur left and right substitution, so it is necessary to dynamically adjust the SFIB entries of different orbits. Based on this, in this embodiment, the inter-satellite communication routing table of different orbits needs to be updated periodically.

In the example embodiment, the data in the satellite data depot is updated based on the data name information, including:
the data of the target satellite is updated based on the data name information; and
the data of all low-orbit satellites and geosynchronous earth orbit satellites in the satellite data depot is updated.

In the practical application, after the target satellite receives the data name information of the producer, the satellite-ground communication routing table inside the target satellite can be updated based on the data name information. After that, the target satellite can send updated information to the geosynchronous earth orbit satellite. The geosynchronous earth orbit satellite can issue a global update instruction. Based on this instruction, the satellites in the satellite data depot update their respective DL forms.

FIG. 5 is the second flow diagram of the data communication method provided by the embodiment of the disclosure.

As shown in FIG. 5, in the example embodiment, in order to prevent the data packet reverse path from being lost caused by the link switching at the cross-seam of the Walker constellation, this embodiment solves the problem by the following method: if a satellite node wants to send the interest packet through the inter-satellite link of the reverse seam, the satellite node will send an A-interest (Auxiliary Interest) packet to its adjacent satellite nodes in the same orbit. The difference between the A-interest packet and the ordinary interest packet is that the hop limit of the A-interest packet is 2. The sending process of A-interest packet is as follows. The purpose of sending A-interest packets is to reconstruct the reverse path of the data packet.

```
  Require:
  RemHops: the amount of remaining hops of A-interest packet, with an
  initial value of 2
  D: the data packet requested by the interest packet Dᵢₙₜ
  Begin
    for node S_{h,i} creates or receives an A-interest packet D_{A} do
      if D has been cached in the CS of S_{h,i} then
        complete the forwarding process
      end if
      if the PIT entry of S_{h,i} has an entry named D then
        complete the forwarding process
      end if
      if RemHops == 0 then
        complete the forwarding process
      else if RemHops == 2 then
        by finding SFIB, D_{A} is forwarded to two adjacent nodes S_{h,i+1}
and S_{h,i-1} in the same orbit
        RemHops− −
      else
        while S_{h,i+1} or S_{h,i-1} re-establish a link connection with Sₕ_{⁺}_{,i}_{⁺} do
          by finding SFIB, D_{A} is forwarded to Sₕ_{⁺}_{,i}_{⁺}
          RemHops − −
          end while
      end if
    end for
  end
```

FIG. 5 shows this process. It can be seen that if link switching occurs, the connection between S_{m,2} and S_{1,3} is re-established and a reverse path S_{m,2}→S_{1,3}→S_{1,2} is constructed.

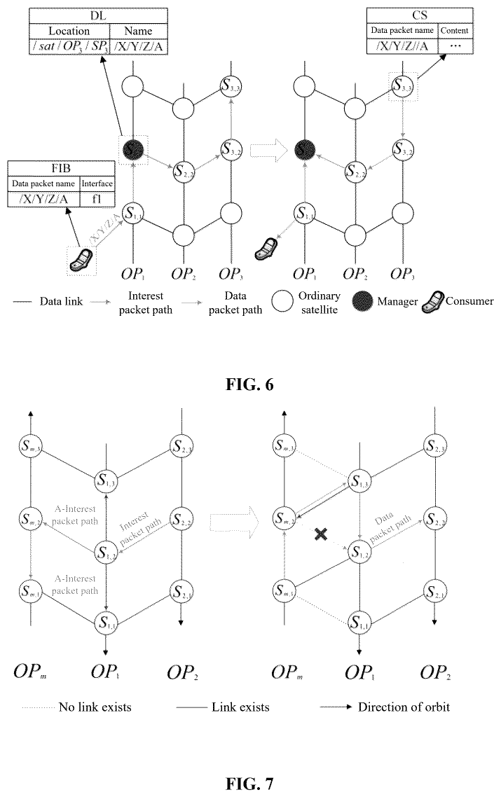

FIG. 6 is the third flow diagram of the data communication method provided by the embodiment of the disclosure.

FIG. 7 is the fourth flow diagram of the data communication method provided by the embodiment of the disclosure.

The overall process of the data communication method in the solution of this application is introduced below:

As shown in FIG. 6 and FIG. 7, if a consumer from the ground forwards the interest packet Dint of the request packet D to the LEO layer satellite, Sₕ_{⁺}_{,i}_{⁺} the packet acquisition process begins.

Step 1: Sₕ_{⁺}_{, i}_{⁺} forwards Dint to the nearest manager Sₕ_{⁺}_{,j} through the SFIB entry.

Step 2: Sₕ_{⁺}_{,j} queries the DL entries it carries and performs the following operations:
If DL has a entry named D and the storage location is S_{h,i}, then step 3 is entered;
If DL does not have an entry named D, Dint will wait at Sₕ_{⁺}_{,j} and repeat step 2.

Step 3: Dint takes the prefix name of S_{h,i} as the forwarding hint, and then Sₕ_{^{+,j}} forwards Dint according to the preset routing algorithm.

Step 4: A will try to hit Dint in the cache. If the cache is not hit in S_{h,i}, S_{h,i} will send a SReq request to P for the data packet D according to the FIB entry.

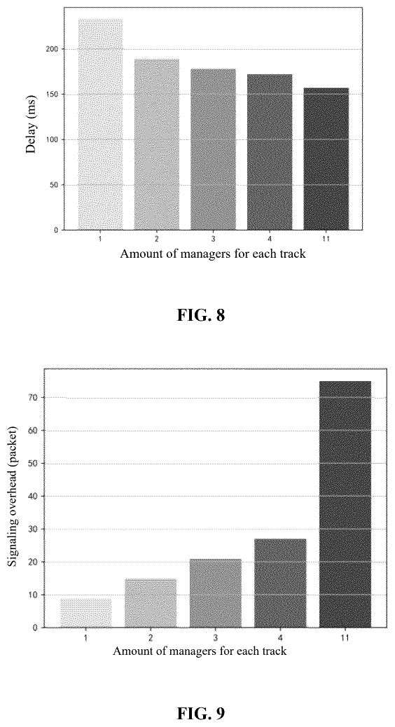

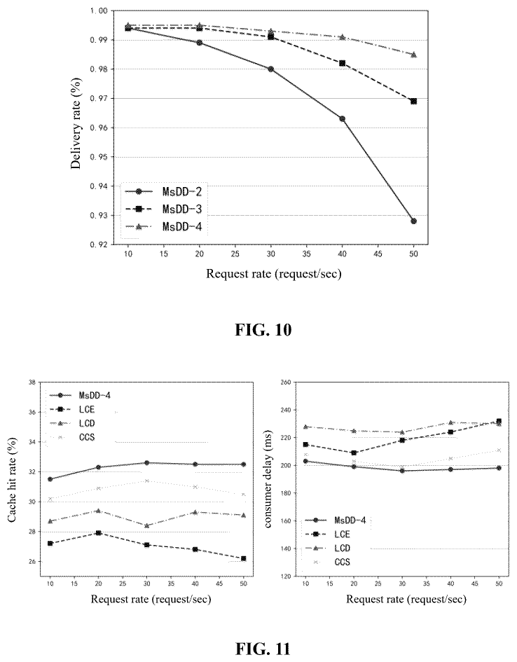

FIG. 8 provides the consumer delay graph under different number of managers for the embodiment of the disclosure. The results of FIG. 8 show that if the amount of managers increases, the consumer delay of MsDD shows a significant downward trend. This is because if there are more managers on an orbit plane, the number of extra hops that the interest packets and the data packets need to pass to their nearest managers on the orbit plane will be less. If the number of the managers on each orbit is 11, the amount of extra hops at this time is 0, so the consumer delay is also the lowest.

FIG. 9 is the signaling overhead graph under different amounts of managers provided by the embodiment of the disclosure. The results in FIG. 9 show that if the amount of the managers increases, the signaling overhead of each DL update in the data collection phase will be greater. This is because managers need to send updated information to GEO satellites in the data collection phase, and if the amount of the managers increases, the more managers that GEO satellites need to send updated information are.

FIG. 9 is the signaling overhead graph under different amounts of managers provided by the embodiment of the disclosure. Solutions with two managers, three managers, and four managers can be named as MsDD-2, MsDD-3, and MsDD-4, respectively, and their average delivery rates are compared if the data rate increases. FIG. 9 shows that if the Interest rate increases, the data packet delivery rate of the three solutions will decrease due to the increase of the amount of data in the network, and MsDD-2 and MsDD-3 decrease more obviously. This is because in MsDD, the manager node will carry a large amount of network traffic, and the fewer the managers are, the greater the load of the inter-satellite link between each manager and different orbits is. Therefore, it is believed that if the amount of the managers on each orbit is two or three, the performance of MsDD cannot be optimal. Therefore, in the subsequent experiments, the solutions MsDD-2 and MsDD-3 were excluded, and MsDD-4 was selected for further experiments.

FIG. 11 is a influence result graph of different intranet caching strategies on the performance of MsDD provided by the embodiment of the disclosure. It can be seen from FIG. 11 that if the request rate increases, the cache hit rate and the consumer delay of MsDD-4 are significantly better than other solutions. This is because the internal caching solution of MsDD-4 prioritizes caching the more popular content in the network based on probability, reducing cache redundancy and decreasing the probability of requested content being replaced. At the same time, MsDD-4 improves the probability that data packets are cached at nodes close to the manager, so that interest packets can hit the cache with fewer hops.

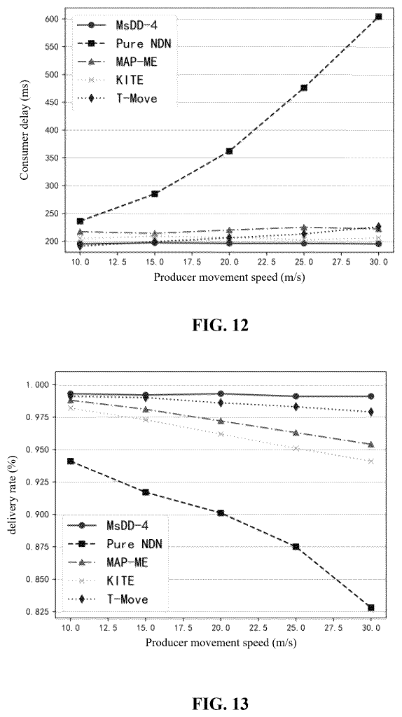

FIG. 12 is the consumer delay graph under different producer movement rates provided by the embodiment of the disclosure. The results of FIG. 12 show that with the increase of the movement speed of the producer, except for Pure NDN, the other schemes have better performance in consumer delay and are stable in a reasonable numerical range. MsDD-4 is the most stable and has an increase of about 5% in consumer delay compared with other solutions.

FIG. 13 is a delivery rate graph under different producer movement rates provided by the embodiment of the disclosure. The results of FIG. 13 show that the delivery rate of MsDD-4 is significantly better than other solutions, and this advantage is more obvious with the increase of the movement speed of the producer. This is because although other solutions can reduce the packet loss problem during handover to a certain extent, the delivery rate will inevitably decrease if the amount of handover events increases. Taking Kite as an example, if the movement speed of the producer increases, the frequency of the producer switching between APs will also increase, which will lead to old path problems, resulting in packet loss.

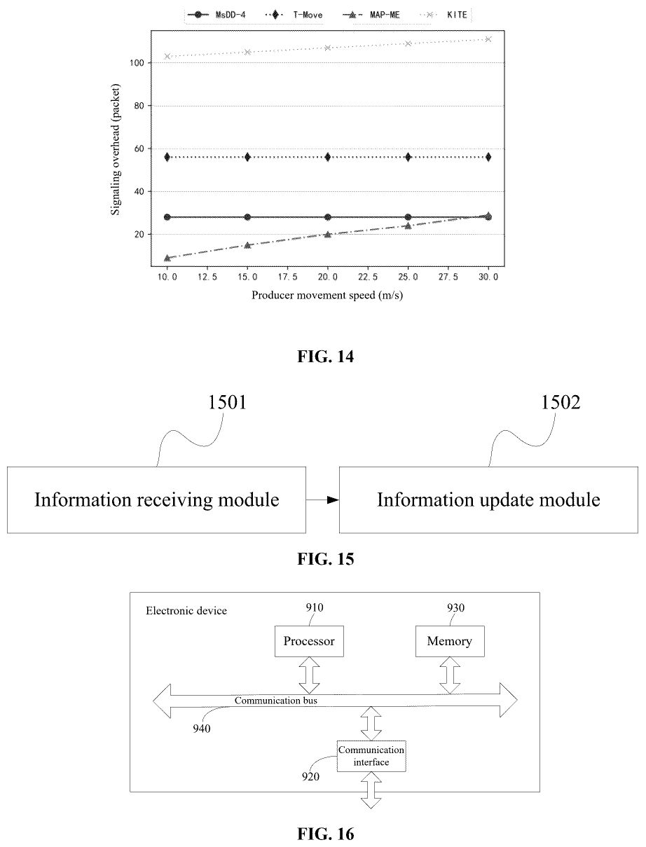

FIG. 14 is a signaling overhead graph under different producer movement rates provided by the embodiment of the disclosure. FIG. 14 shows the change of signaling overhead if the movement speed of the producer increases, wherein the signaling overhead which is calculated is the case if satellite switching occurs in MsDD. It can be seen that the signaling overhead of MsDD remains stable with the change of the movement speed of the producer, and is better than that of Kite and T-Move. This is due to the fact that if the producer moves, Kite needs to frequently send TI/TD packets to the producer to update the tracking path, while T-Move needs to send messages to update FIB before and after handover. The signaling overhead of MsDD is only related to the amount of the managers, because the GEO controller only sends update information to managers.

The data communication system provided by the disclosure is described below. The data communication system described below and the data communication method described above can refer to each other.

FIG. 15 is a structure diagram of the data communication system provided by the embodiment of the disclosure;

As shown in FIG. 15, the data communication system provided in this embodiment includes:
an information receiving module 1501, which is configured to receive the data name information uploaded by the producer through the pre-built satellite data depot. The satellite data depot includes at least three geosynchronous earth orbit satellites and several low-orbit satellites, and the data name information characterizes the data produced by the producer; and
an information update module 1502, which is configured to the data in the satellite data depot based on the data name information.

In the example embodiment, the data communication system also includes a data forwarding module, which is specifically configured to:
forward the request packet to the producer if the satellite data depot receives the request packet of the consumer; and
receive the data packet uploaded by the producer based on the request packet and forward the data packet to the consumer through the satellite data depot.

In the example embodiment, the data forwarding module is also configured to:
receive the request packet of the consumer through the low-orbit satellites;
mark the request packet based on the data name information; and
route the request packet to the producer based on markings.

In the example embodiment, the data forwarding module is also configured to:
route the request packet to the target satellite based on the preset routing rules, wherein the address of the target satellite corresponds to the markings; and
forward the request packet to the producer based on the data name information of the producer through the target satellite.

In the example embodiment, the data communication system also includes a cache forwarding module, which is specifically configured to:
forward the cached data packet to the consumer if the satellite data depot receives the request packet of the consumer, and it is determined that the satellite data depot has cached the data packet corresponding to the request packet.

In the example embodiment, the data communication system also includes a cache module, which is specifically configured to:
determine the number of times that the date packet is requested;
determine a corresponding number of hops for each low-orbit satellite through which the data packet passes if the data packet is requested each time;
calculate the cache probability of each low-orbit satellite to the data packet based on the requested times and the hop times of the data packet; and
cache the data packet based on the cache probability through each low-orbit satellite.

In the example embodiment, the data communication system also includes a routing table construction module, which is specifically configured to:
send the first information to the low-orbit satellite in the same orbit for each low-orbit satellite, the first information characterizes the location of the low-orbit satellite;
create and store the inter-satellite communication routing table in the low-orbit satellite in the same orbit if the low-orbit satellite in the same orbit receives the first information, and the inter-satellite communication routing table corresponding to the low-orbit satellite is not stored in the low-orbit satellite in the same orbit; update the inter-satellite communication routing table based on the first information if the inter-satellite communication routing table corresponding to the low-orbit satellite has been stored;
send the second information to the low-orbit satellites of different orbits every set time for each low-orbit satellite, the second information characterizes the position of the low-orbit satellite; and
create and store the inter-satellite communication routing table in the low-orbit satellite in different orbits if the low-orbit satellite in different orbits receives the second information, and the inter-satellite communication routing table corresponding to the low-orbit satellite is not stored in the low-orbit satellite in different orbits; update the inter-satellite communication routing table based on the second information if the inter-satellite communication routing table corresponding to the low-orbit satellite has been stored.

In the example embodiment, the data communication system is also configured to:
update the data of the target satellite based on the data name information; and
update the data of all low-orbit satellites and geosynchronous earth orbit satellites in the satellite data depot.

The specific implementation method of the data communication system provided by the embodiment can be implemented with reference to the above embodiment, which is not repeated here.

FIG. 16 shows a schematic diagram of the physical structure of an electronic device. As shown in FIG. 16, the electronic device can include: a processor 910, a communication interface 920, a memory 930 and communication bus 940, wherein the processor 910, the communication interface 920 and the memory 930 complete communication with each other through the communication bus 940. The processor 910 can call the logic instructions in the memory 930 to perform the data communication method, which includes:
the data name information uploaded by the producer is received through the pre-built satellite data depot, which includes at least three geosynchronous earth orbit satellites and several low-orbit satellites, and the data name information characterizes the data characterized by the producer; and
the data in the satellite data depot is updated based on the data name information.

In addition, the logic instructions in the above memory 930 can be implemented in the form of software functional units and can be stored in a computer-readable storage medium if sold or used as an independent product. Based on this understanding, the technical solution of the present disclosure essentially or the part that contributes to the existing technology or the part of the technical solution can be reflected in the form of a software product. The computer software product is stored in a storage medium, including several instructions to enable a computer device (can be a personal computer, server, or network device, etc.) to perform all or part of the steps of each embodiment method of the present disclosure. The aforementioned storage media include: U disk, mobile hard disk, read-only memory (ROM, Read-Only Memory), random access memory (RAM, Random Access Memory), disk or disc and other media that can store program code.

On the other hand, the present disclosure also provides a computer program product, which includes a computer program. The computer program can be stored on a non-transient computer readable storage medium. If the computer program is executed by the processor, the computer can perform the data communication method provided by the above methods. On the other hand, the present disclosure also provides a non-transient computer readable storage medium on which computer programs are stored, which are implemented by the processor if it is executed to perform the data communication methods provided by the above methods.

The device embodiment described above is only schematic, in which the unit described as a separation component can be or can not be physically separated, and the component displayed as a unit can be or can not be a physical unit, that is, it can be located in one place, or can also be distributed to multiple network units. According to the actual needs, some or all of the modules can be selected to achieve the purpose of this embodiment solutions. Those of ordinary skill in the art can understand and implement it without the effort of creativity.

Finally, it should be explained that the above embodiments are only used to illustrate the technical solution of the present disclosure, rather than to restrict it. Although the present disclosure is described in detail with reference to the aforementioned embodiments, those of ordinary skill in the art should understand that they can still modify the technical solutions recorded in the aforementioned embodiments, or replace some of the technical features equivalently; these modifications or replacements do not make the essence of the corresponding technical solution separate from the spirit and scope of the technical scheme of each embodiment of the present disclosure.

1. A data communication method, comprising:
receiving data name information uploaded by a producer through a pre-built satellite data depot; the satellite data depot comprises at least three geosynchronous earth orbit satellites and several low-orbit satellites, and the data name information characterizes data produced by the producer; and
updating the data in the satellite data depot based on the data name information.

2. The data communication method according to claim 1, wherein the method further comprises:
forwarding a request packet to the producer if the satellite data depot receives the request packet of the consumer; and
receiving a data packet uploaded by the producer based on the request packet and forwarding the data packet to the consumer through the satellite data depot.

3. The data communication method according to claim 2, wherein the forwarding a request packet to the producer if the satellite data depot receives the request packet of the consumer comprises:
receiving the request packet of the consumer through the low-orbit satellites;
marking the request packet based on the data name information; and
routing the request packet to the producer based on markings.

4. The data communication method according to claim 3, wherein the satellite data depot receives the data name information uploaded by the producer through the target satellite, and the target satellite is one of several low-orbit satellites;
the routing the request packet to the producer based on the markings comprises:
routing the request packet to the target satellite based on preset routing rules, wherein the address of the target satellite corresponds to the markings; and
forwarding the request packet to the producer based on the data name information of the producer through the target satellite.

5. The data communication method according to claim 2, wherein the method further comprises:
forwarding the cached data packet to the consumer if the satellite data depot receives the request packet of the consumer, and it is determined that the satellite data depot has cached the data packet corresponding to the request packet.

6. The data communication method according to claim 5, wherein the satellite data depot caches the data packet by the following method:
determining number of times that the date packet is requested;
determining a corresponding number of hops for each low-orbit satellite through which the data packet passes if the data packet is requested each time;
calculating cache probability of each low-orbit satellite to the data packet based on the requested times and the hop times of the data packet; and
caching the data packet based on the cache probability through the each low-orbit satellite.

7. The data communication method according to claim 1, wherein the routing table comprises a satellite-ground communication routing table and a inter-satellite communication routing table; the low-orbit satellites are distributed in several orbits; the construction method of the inter-satellite communication routing table comprises:
sending first information to the low-orbit satellite in the same orbit for each low-orbit satellite, the first information characterizes the location of the low-orbit satellite;
creating and storing the inter-satellite communication routing table in the low-orbit satellite in the same orbit if the low-orbit satellite in the same orbit receives the first information, and the inter-satellite communication routing table corresponding to the low-orbit satellite is not stored in the low-orbit satellite in the same orbit; updating the inter-satellite communication routing table based on the first information if the inter-satellite communication routing table corresponding to the low-orbit satellite has been stored;
sending second information to the low-orbit satellites of different orbits every set time for each low-orbit satellite, the second information characterizes the position of the low-orbit satellite; and
creating and storing the inter-satellite communication routing table in the low-orbit satellite in different orbits if the low-orbit satellite in different orbits receives the second information, and the inter-satellite communication routing table corresponding to the low-orbit satellite is not stored in the low-orbit satellite in different orbits; updating the inter-satellite communication routing table based on the second information if the inter-satellite communication routing table corresponding to the low-orbit satellite has been stored.

8. The data communication method according to claim 4, wherein the updating the data in the satellite data depot based on the data name information comprises:
updating the data of the target satellite based on the data name information; and
updating the data of all low-orbit satellites and geosynchronous earth orbit satellites in the satellite data depot.

9. A data communication system, comprising:
an information receiving module, configured to receive data name information uploaded by a producer through a pre-built satellite data depot; the satellite data depot comprises at least three geosynchronous earth orbit satellites and several low-orbit satellites, and the data name information characterizes the data produced by the producer; and
an information update module, configured to update the data in the satellite data depot based on the data name information.

10. A an electronic device, comprising: a memory, a processor, and a computer program stored on the memory and executable on the processor, the processor implements the data communication method as claimed in claim 1 if executing the program.
